(19) United States
(12) Patent Application Publication
(10) Pub. No.: US 2006/0052986 A1
(43) Pub. Date: Mar. 9, 2006

(54) Method and apparatus for animal environmental and health monitoring

(75) Inventors: Robert A. Rogers, Saratoga, CA (US); Russell E. Blette, Hastings, MN (US)

Correspondence Address: HEIMLICH LAW, 5952 DIAL WAY, SAN JOSE, CA, 95129, US

(73) Assignee: Equividi, Inc., Saratoga, CA (US)

(21) Appl. No.: 10/922,696

(22) Filed: Aug. 20, 2004

(51) Int. Cl. G06F 15/00; H03F 1/26; H04B 15/00

(52) U.S. Cl. 702/189

(57) ABSTRACT

A method and apparatus for animal environmental and health monitoring have been disclosed. In one embodiment of the invention the monitoring provides on-site and/or off-site real-time information on such things as heart rate, water usage, respiration, temperature, movement, tracking of location, and who is handling the animal.

### FIELD OF THE INVENTION

The present invention pertains to environmental and health monitoring. More particularly, the present invention relates to a method and apparatus for animal environmental and health monitoring.

### BACKGROUND OF THE INVENTION

Animals can represent a significant investment. For example, prize horses can cost hundreds of thousands of dollars or more to purchase. Another example, endangered species in research environments are priceless and cannot be replaced. Additionally, there are training costs, feed, care, entry fees, etc. When animals become sick there are medical costs.

Animals cannot effectively communicate their condition. Trainers, handlers, research assistants and owners as well as veterinarians can get a “feel” for the animal's condition based on experience; however, this is not consistent and may be misleading.

Currently, there are several products to monitor certain aspects of an animal. For example, there are animal heart rate monitors. These monitors can set heart rate limits to trigger an alarm, measure time in a target zone, etc. There are also body temperature measuring devices. These devices each measure a particular parameter and may not give an overall “picture” of the animal's health. This may present a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented;

FIG. 2 is a block diagram of a computer system which may be used for implementing some embodiments of the invention;

FIG. 3 illustrates one embodiment of the invention showing water usage monitoring;

FIG. 4 illustrates one embodiment of the invention showing a water usage sensor;

FIG. 5 illustrates one embodiment of the invention showing multiple stalls and displays;

FIG. 6A and FIG. 6B illustrate embodiments of the invention showing user input and control;

FIG. 7 illustrates one embodiment of the invention showing local and remote displays and a display monitoring computer system,

FIG. 8 illustrates one embodiment of the invention showing local displays in wireless communication with a display monitoring computer system;

FIG. 9 illustrates one embodiment of the invention showing various communicating methods;

FIG. 10 illustrates one embodiment of the invention showing a display and control panel; and

FIG. 11 illustrates in flow chart form one embodiment of the present invention.

### DETAILED DESCRIPTION

The invention, as exemplified in various embodiments, illustrates animal environmental and health monitoring

Livestock (also called animal) investments can have a significant value in dollars in today's market. Because of this large investment in money and time, owners and trainers want the earliest warning possible of any change in animal health or routine. For example, changes such as the amount of water intake, heart rate, restlessness, and temperature can be indicators of the start of an illness. In addition strict adherence to a regular schedule supplements the health and training of the animal. Because owners cannot always be present to verify that the schedules are consistent or that they occurred at all, monitoring movements of the animal from station to station will verify that training feeding, etc. has taken place at the scheduled time. As the price of livestock goes up in value, tampering and theft also becomes an issue. Position monitoring at off times could also be a warning that someone is tampering with or stealing a valuable animal. Additionally, animals that are endangered and/or used for research may benefit from careful monitoring.

In one embodiment of the invention, a standalone monitor measures water consumption. For example, the standalone monitor may be digital and provide an owner with the amount of water being drunk over a set period of time. In one embodiment of the invention, the monitoring device is designed to attach to the line that supplies the water to the animal via a self-watering bowl or larger container. A float mechanism is activated when the water level is below a set point. Adapters may be used to reduce or increase the size of the openings to fit on the existing water pipe.

In another embodiment of the invention, inside of a connection going to the water supply line is a small impellor that turns as the water fills the container. It is calibrated to report, for example, one revolution for a set amount of water moving past it. One revolution could be equal to a tenth of a gallon, thus 10 revolutions would be equal to one gallon. The unit sends a pulse each time a full revolution occurs. A control board receives the pulse and stores the information. A total is calculated each time a pulse is received. The total is displayed on a panel, such as an LCD panel, connected to the monitoring device via a wire. The display is at the monitoring location or at a user designated location remotely located.

In one embodiment of the invention, the monitoring device may connect to a number of stalls or paddocks and report this information on one panel. Mounting of the single unit, or multiple units, may be done at one or more locations so as to allow the user easy viewing. The monitoring device may collect the information over a number of days, such as a one or two week period, or may keep a permanent record for longer periods.

In one embodiment of the present invention, after the user reviews the usage report it may be reset or left to show the current information until it reaches the number of days maximum set by the user. The user may reset the device when it reaches the maximum or earlier if they have recorded the information. The display will then begin to collect and report the information.

In one embodiment of the invention, the communications is wireless. For example, a wireless embodiment of the monitor will transmit the information to the display monitoring system (DMS) or to a display monitoring computer station (DMCS) in situations where the user does not want to, or cannot, run wires.

In one embodiment of the invention, a display monitoring station (DMS) and/or a standalone display monitor (SDM) can record longer time frames. The DMS can also store and display information from multiple standalone display monitors. The SDMs may be connected to the DMSs by wires or wireless transmitters. By using a monitoring station that can maintain complete histories of information, a richer set of reports and calculations allow the user to calculate norms and set, for example, a set of alarms to indicate something has changed in the drinking pattern of the animal. LCDs on the panel can show the time frame, the normal amount of water used for the time frame, and the amount of difference from normal. A user can set a percentage of difference that will trigger an alarm signal. A keypad on the station allows the user to input the stall number to display. A constant display of a stall that has triggered the monitor may be set. Scrolling stations can also be set to constantly report the information. A learning feature allows the collection of norms by stall. Upon completion of the learning process the user can begin to see reports of the differences. The DMS may have a wired and/or wireless connection capability to communicate with a designated computer for tracking of multiple DMSs and to increase the number of reports and alarm options.

In one embodiment of the invention, the DMCS will communicate with SDMs and DMSs. It can report the same information as the DMS for all stations. Additionally, it will have more capability to provide detailed reports, and to trigger more alarms and communicate such via pagers, cell phones, email, external horns, bells, etc. The DMCS will monitor the heart monitor probe, body temperature probe, motion detector, RFIDs, etc.

In one embodiment of the invention water usage, heart rate, body temperature, movement, respiration, and people handling and moving the animals from place to place are monitored.

In one embodiment of the invention, the system ranges from a monitor for various health and/or environmental indicators to a computerized data collection system. The user is able to set ranges with each monitored feature that would alert key persons if any of the ranges were exceeded. Monitor probes are placed in the animal's environment and on (or in) the animal to pick up the information. Antennas, wireless transmitters, listening devices, and camera devices may be used to collect information and transmit it to the computer system and/or monitoring panel. The monitoring may be in real time to quickly identify problems and notify someone of the need to act.

In one embodiment of the invention the monitoring system is composed of self-contained probes and/or sensors, wired and wireless probes or sensors, a centralized monitor station with readouts, a computer station in an n+1 configuration, antennas, repeaters, network components, and alarms. There are various configurations that are application and customer needs selectable.

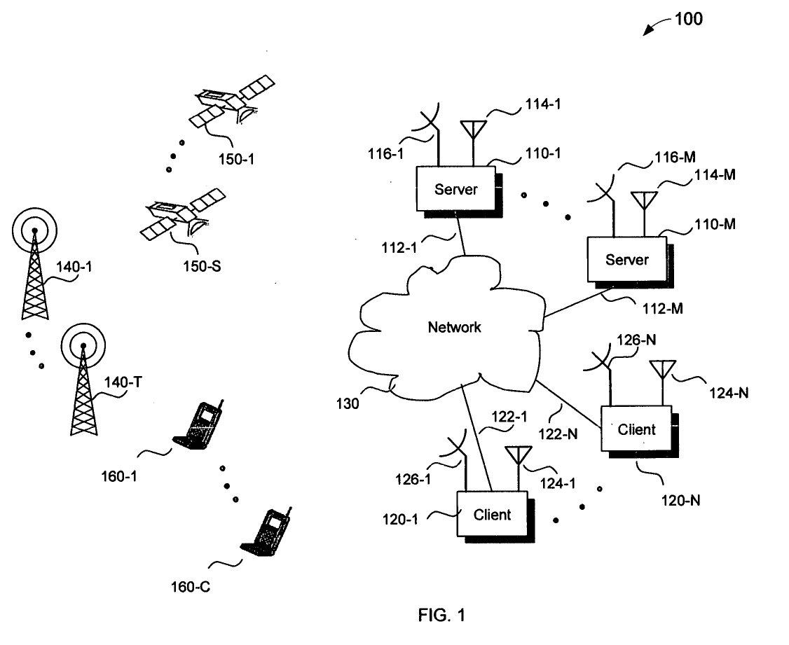

FIG. 1 illustrates a network environment 100 in which the techniques described may be applied. More details are described below.

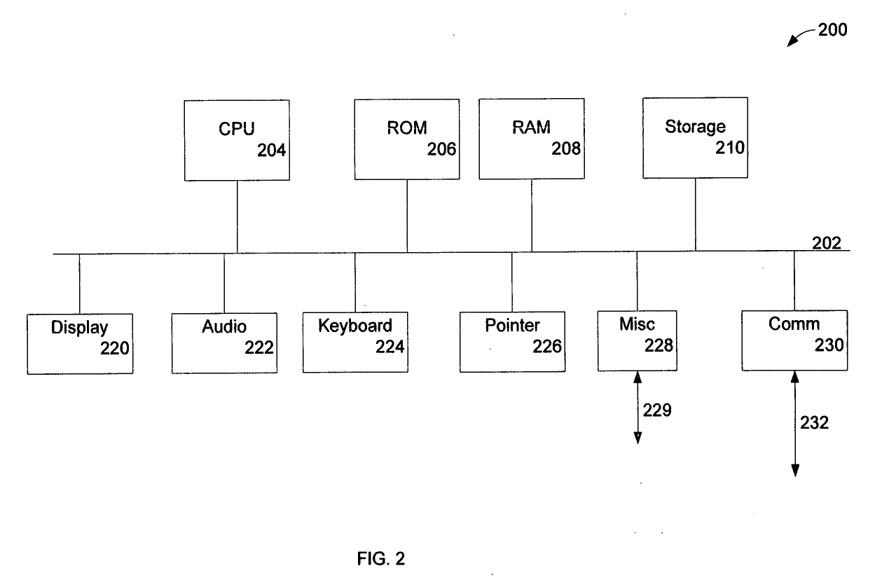

FIG. 2 illustrates a computer system 200 in block diagram form, which may be representative of any of the devices shown in FIG. 1. More details are described below.

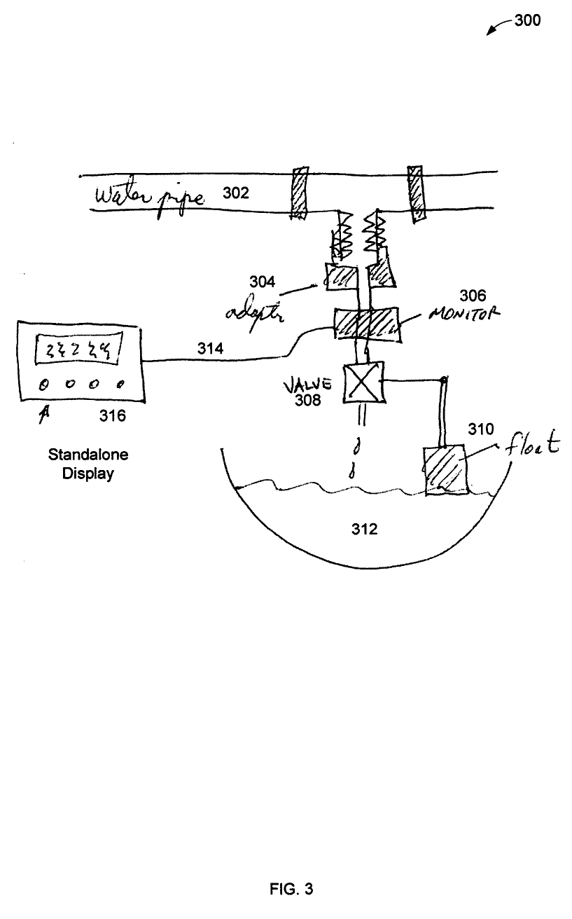

FIG. 3 illustrates one embodiment 300 of the invention. At 302 is a water pipe which connects to an adapter 304. Mounted off of the adapter 304 is a monitor device 306 which monitors the water flow through valve 308 into bowl 312. Valve 308 is controlled by the float 310 measuring the height of the water in bowl 312. Monitor 306 is in communication with, via 314, a standalone display 316. Display 316 may have a readout of the water as well as limits, reset buttons, etc.

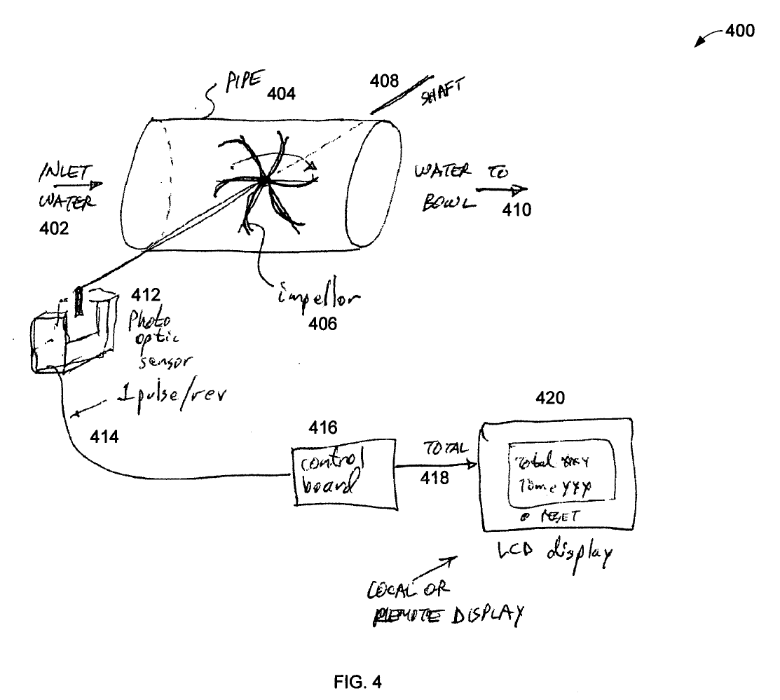

FIG. 4 illustrates one embodiment 400 of the invention. At 402 is a water inlet which connects to a pipe 404 and water flows 410 to a bowl. Within the pipe 404, mounted on a shaft 408, is an impellor 406 which rotates with water flow. On the shaft 408 is mounted an opaque flange that interrupts photo optic sensor 412 once per revolution generating a pulse which is communicated via 414 to a control board 416 which sends a total via 418 to an LCD display 420. LCD display 420 may be mounted locally or remotely. LCD display 420 may have buttons for such functions as reset, backlighting, etc.

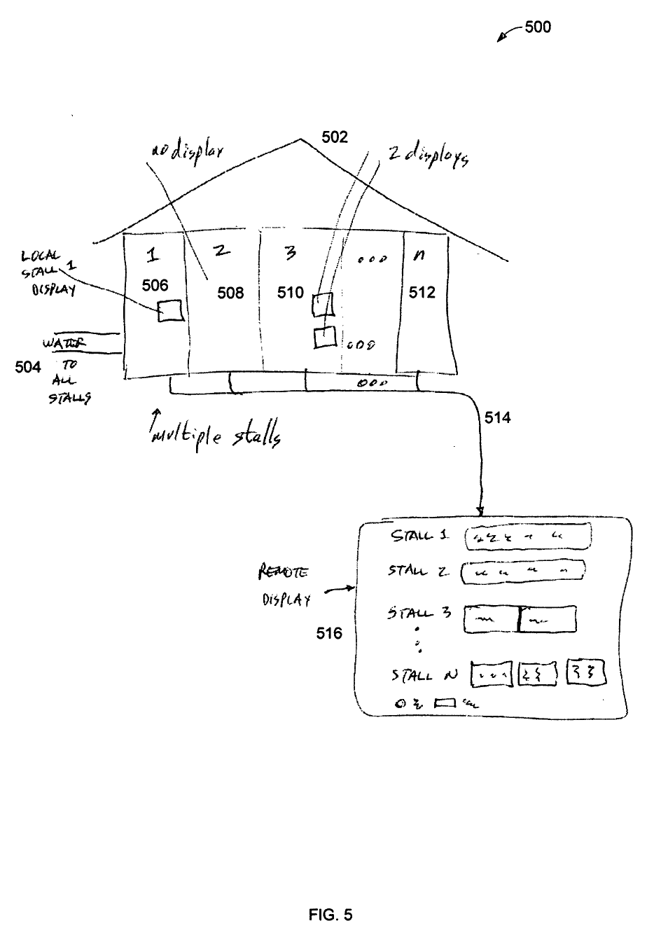

FIG. 5 illustrates one embodiment 500 of the invention. At 502 is a structure having multiple stalls (1,2,3, . . . n) (506, 508, 510, . . . 512 respectively) which has a water inlet 504 going to the stalls. Stall 1 506 has a single local display. Stall 2 508 has no local display. Stall 3 510 has two local displays. Stall n 512 may represent any number of stalls. All the stalls 1 . . . n are in communication with a remote display 516 via communication channel 514. Display 516 in this embodiment shows all the stalls in several different formats. For example, stalls 1 and 2 each have a single large display whereas stall 3, which had two local displays, has 2 smaller remote displays.

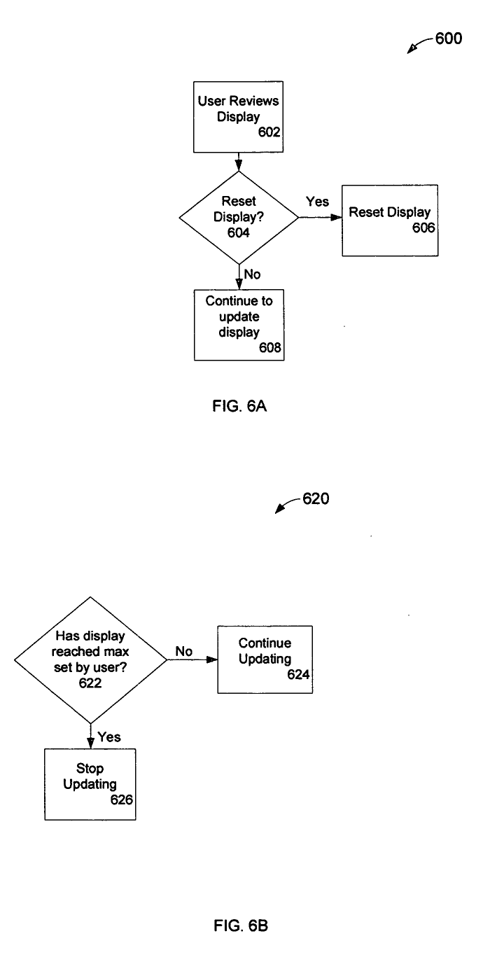

FIG. 6A illustrates one embodiment 600 of the invention. At 602 a user reviews the display. At 604 a check is made to see if the user requested a reset of the display. If the user did not request a reset of the display then at 608 the display continues to be updated. If the user did request a reset of the display, then at 606 the display is reset.

FIG. 6B illustrates one embodiment 620 of the invention. At 622 a check is made to see if the display has reached a maximum value or limit as set by the user. If no maximum has been reached, then at 624 the updating continues. If one or more maximums have been reached and/or exceeded then at 626 updating is stopped.

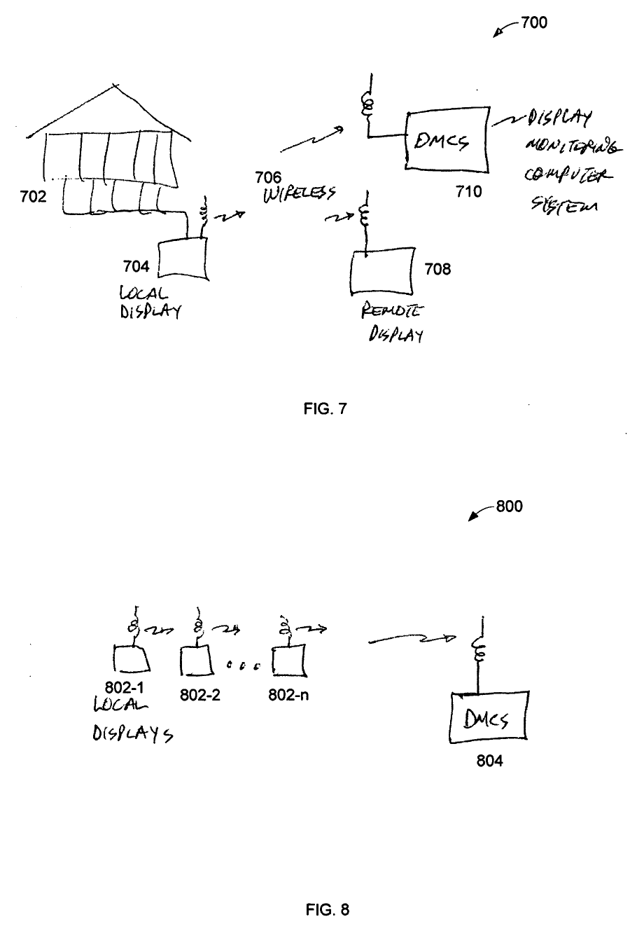

FIG. 7 illustrates one embodiment 700 of the invention. At 702 are a series of stalls that are in communication with a local display 704. Local display 704 is in wireless communication 706 with a remote display 708 and/or a display monitoring computer system (DMCS) 710. In this embodiment, the DMCS may track long time trends, store information for later analysis and retrieval, perform real-time monitoring to check against preset limits, send warnings, etc.

Remote display 708 may be at a fixed location or may be mobile. For example, remote display 708 may be carried or worn by the user in the form of, for example, a PDA, a cell phone, a heads-up display, etc. In one embodiment, the user as they walk by each stall may view a display of information related to the animal(s) in that stall. The data may be in the form of individual data or aggregate data. The user may also query the local display and/or the DMCS for additional information.

FIG. 8 illustrates one embodiment 800 of the invention. At 802-1 through 802-n are a series of local displays that are in communication with a DMCS 804. One of skill in the art will appreciate that the local displays may be in communication with more than a single DMCS. For example, a head horse trainer may have a DMCS unit at a headquarters location, a theft monitoring service may have one, a veterinarian may have another, and an owner may want one as well.

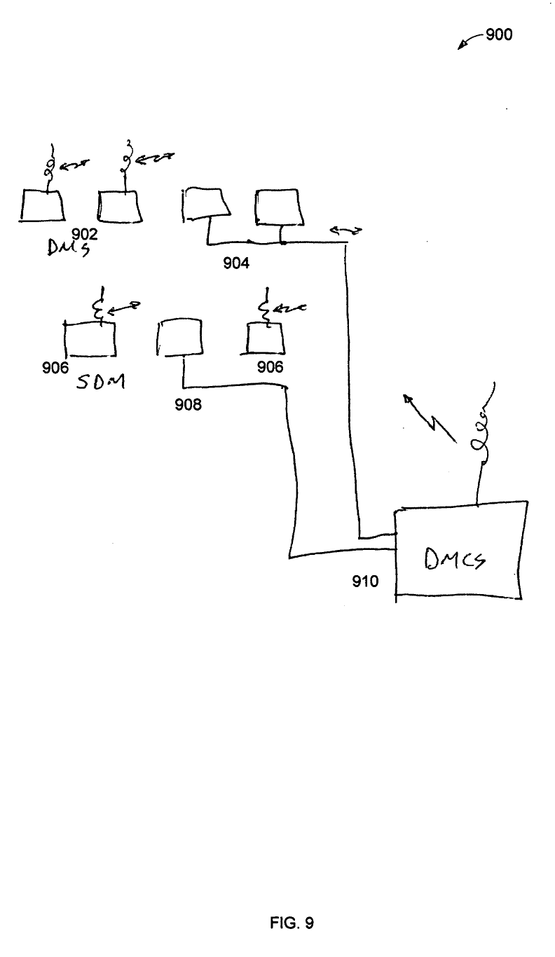

FIG. 9 illustrates one embodiment 900 of the invention. Here a series of DMS units (902 and 904) are in communication with a DMCS 910 via wireless (for 902) and wired (for 904) links. Also in communication with the DMCS 910 are wireless SDMs 906, and wired SDM 908. As illustrated, the DMCS 910 is able to communicate information and settings to the DMSs and the SDMs. This information may be, but is not limited to, such things as new local limits, the rate at which monitoring is to take place, resetting a unit, etc. Additionally, the SDMs and DMSs may be capable of bidirectional communication with each other as well as one or more DMCSs. What is to be appreciated is that depending upon what is needed, communications may be initiated and received by one or more DMSs, SDMs, and DMCSs.

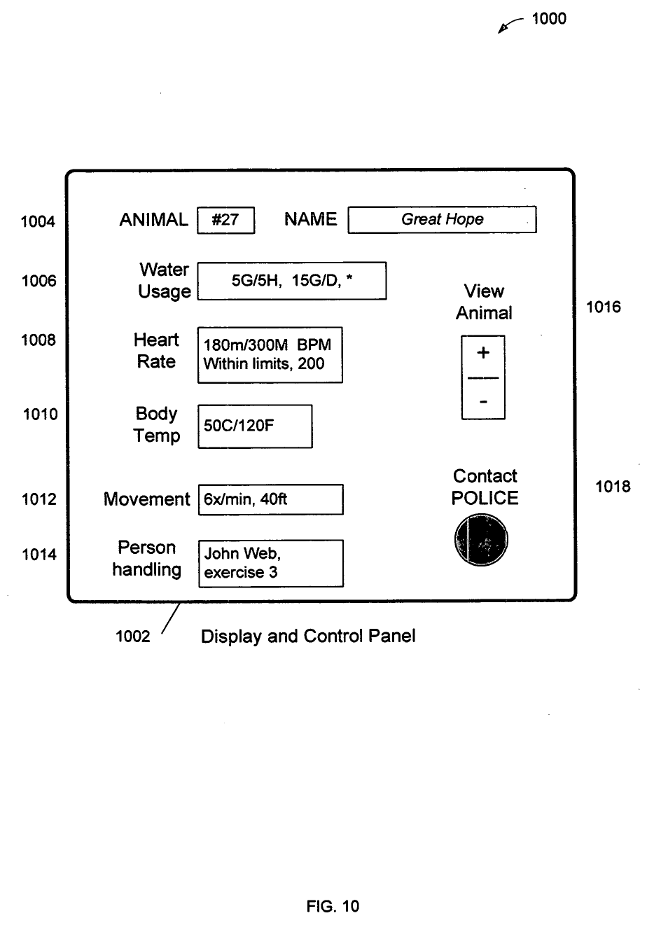

FIG. 10 illustrates one embodiment 1000 of the invention. Here, a display and control panel 1002 are shown. At 1004 is a display indicating the animal whose information is being displayed and the animal's name. At 1006 is the water usage, at 1008 the heart rate, at 1010 the body temperature, at 1012 information on movement, and at 1014 the person handling the animal. At 1016 is an input device that allows the user to select which animal information to display. There may be other controls and displays. For example, at 1018 is a button to automatically contact the police. This may be used when a theft of an animal is suspected. Such information as the owner of the animal, current and/or last known location, description, etc. may be automatically communicated to the proper authorities. One of skill in the art will appreciate that this may be expanded to include such things as monitoring the temperature of stalls, the detection of a fire, alerting firefighters, etc.

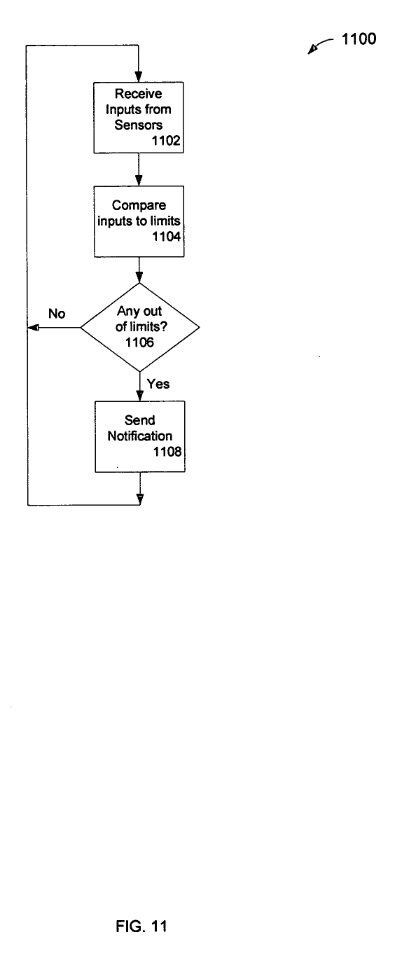

FIG. 11 illustrates one embodiment 1100 of the invention. At 1102 inputs from sensors are received. At 1104 these inputs from the sensors are compared against limits and/or ranges. At 1106 a determination is made to see if any sensor inputs have reached or exceeded limits and/or ranges. If not, then the monitoring continues (at 1102). If any sensor inputs have reached or exceeded limits and/or ranges than at 1108 a notification is sent and then monitoring continues (at 1102). Notification may be sent via email, pager, instant messaging, ringing a bell or alarm, etc.

Thus a method and apparatus for animal environmental and health monitoring have been described.

Referring back to FIG. 1, FIG. 1 illustrates a network environment 100 in which the techniques described may be applied. A plurality of computer systems are shown in the form of M servers (110-1 through 110-M), and N clients (120-1 through 120-N), which are coupled to each other via network 130. A plurality of terrestrial based wireless communications links are shown in the form of T towers (140-1 through 140-T). A plurality of space based communications links are shown as S satellites (150-1 through 150-S). A plurality of personal communication devices are shown in the form of C cell phones (160-1 through 160-C). The M servers and N clients may also be coupled to each other via space based communications links 150-1 through 150-S, as well as terrestrial based wireless communications links 140-1 through 140-T, or a combination of satellite and terrestrial wireless links. Additionally, the C cell phones 160-1 through 160-C may be in communication with the satellites 150-1 through 150-S and/or the terrestrial wireless links 140-1 through 140-T.

Servers 110-1 through 110-M may be connected to network 130 via connections 112-1 through 112-M, respectively. Servers 130-1 through 130-M may be connected to the terrestrial links 140-1 through 140-T via antennae 114-1 through 114-M, respectively. Servers 110-1 through 110-M may be connected to space based communications links 150-1 through 150-S via dish antennae 116-1 through 116-M. Clients 120-1 through 120-N may be connected to the network 130 via connections 122-1 through 122-N. Clients 120-1 through 120-N may be connected to the terrestrial links 140-1 through 140-T via antennae 124-1 through 124-N. Clients 120-1 through 120-N may be connected to space based communications links 150-1 through 150-S via dish antennae 126-1 through 126-N. Cell phones 160-1 through 160-C may be connected to the terrestrial links 140-1 through 140-T and/or space based communications links 150-1 through 150-S via antennae on each respective cell phone. Clients 120-1 through 120-N may also be connected to web sites, search engines, and/or database resources represented by servers, such as servers 110-1 through 110-M, via the network 130, through connections 122-1 through 122-N.

Clients 120-1 through 120-N may consist of, but are not limited to, for example, a desktop computer, a wireless lap top computer, a set-top box, a receiver, a television, a game platform, or other receiving devices. Applications may be running on the clients 120-1 through 120-N, while web pages and information being browsed may reside on the servers 110-1 through 110-M. Broadcasts may be coming from terrestrial sources 140-1 through 140-T, and/or satellite links 150-1 through 150-S. For purposes of explanation, a single client 120-1 and a single car 160-1 will be considered to illustrate one embodiment of the present techniques. It will be readily apparent that such techniques may be easily applied to multiple clients and cars.

Network 130 may be a Wide Area Network (WAN), which includes the Internet, or other proprietary networks, such as America On-Line®, CompuServe®, Microsoft Network©, and Prodigy®. Note that alternatively, the network 130 may include one or more of a Local Area Network (LAN), modem links, satellite link, fiber network, cable network, or any combination of these and/or others. Network 130 may also include network backbones, long-haul telephone lines, Internet service providers, and various levels of network routers. Terrestrial links 140-1 through 140-T may be, for example, wireless cellular telephone service providers. Space based communications links 170-1 through 170-S may be, for example, satellite broadcasters, global positioning satellites (GPS), etc. Communications networks for the present invention may be implemented in any number of environments.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

Thus a method and apparatus for animal environmental and health monitoring have been described.

As used in this description “livestock”, “animal”, or similar phrases are to be understood to refer to non-humans.

As used in this description, “personal communication devices” or similar phrases are to be understood to refer to devices capable of sending and/or receiving information, such as, but not limited to, personal digital assistants (PDAs), cell phones, personal organizers, pagers, wireless laptop computers, desktop computers, as well as machines capable of send and/or receiving information such as, but not limited to, faxes, email, instant messages, etc.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory, and/or logic circuitry. These algorithmic descriptions and representations are the means used by those of skill in the arts to most effectively convey the substance of their work to others of skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities.

Further, any of the methods according to the present invention can be implemented in hard-wired circuitry, by programmable logic, or by any combination of hardware and software.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software.

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for animal environmental and health monitoring have been described.

What is claimed is:

1. A method comprising:
monitoring a plurality of parameters associated with an animal; and
sending an alert based on said monitoring.

2. The method of claim 1 wherein said parameters are selected from the group consisting of water consumption, heart rate, body temperature, movement, respiration, people handling, location, ambient temperature, ambient humidity, and ambient winds.

3. The method of claim 1 wherein said sending an alert is sending an alert to one or more entities.

4. The method of claim 3 wherein said entities are selected from the group consisting of a person, a monitoring system, a sprinkler, a fire department, an agency, and a healthcare professional.

5. The method of claim 1 wherein said alert is received at one or more devices selected from the group consisting of a pager, a phone, a cellular phone, an email, and a video display.

6. The method of claim 1 further comprising communicating a payment and/or credit.

7. An apparatus comprising:
means for monitoring a plurality of parameters associated with an animal; and
means for sending an alert based on said monitored parameters.

8. The apparatus of claim 7 wherein said plurality of parameters are selected from the group consisting of water consumption, heart rate, body temperature, movement, respiration, people handling, location, ambient temperature, ambient humidity, and ambient winds.

9. The apparatus of claim 7 wherein said means for sending an alert is means for sending an alert to one or more entities.

10. The apparatus of claim 9 wherein said entities are selected from the group consisting of a person, a monitoring system, a sprinkler, a fire department, an agency, and a healthcare professional.

11. The apparatus of claim 7 wherein said alert is received at one or more devices selected from the group consisting of a pager, a phone, a cellular phone, an email, and a video display.

12. The apparatus of claim 7 further comprising means for communicating a payment and/or credit.

13. A method comprising:
real-time monitoring of one or more animal indicators;
comparing said animal indicators against predefined limits; and
sending a real-time message when said limits are reached.

14. The method of claim 13 wherein said animal indicators are selected from the group consisting of heart rate, water usage, respiration, temperature, movement, tracking of location, and who is handling the animal.

15. The method of claim 13 further comprising:
receiving said real-time monitoring; and
communicating said real-time monitoring to a monitoring station.

16. An apparatus comprising:
one or more devices for monitoring parameters associated with an animal;
means for connecting said one or more devices to a station; and
means for said station to send an alert.

17. The apparatus of claim 16 wherein said one or more devices are in communication with one or more animals.

18. The apparatus of claim 16 further comprising;
means for controlling one or more of said parameters.

19. The apparatus of claim 18 wherein said parameters are selected from the group consisting of water usage, heart rate, temperature, and movement.

20. A machine-readable medium having stored thereon information representing the apparatus of claim 16.

21. An apparatus comprising:
one or more monitoring devices have inputs and outputs, said inputs connected to sensors;
one or more monitoring stations having inputs and outputs, said inputs coupled to receive said monitoring devices' outputs; and
one or more displays having inputs and outputs, said inputs coupled to receive said monitoring station outputs, and said outputs presenting information.

22. The apparatus of claim 21 wherein said monitoring devices are selected from the group consisting of animal monitoring devices, and environmental monitoring devices.

23. The apparatus of claim 21 further comprising:
one or more computer based monitoring systems having inputs and outputs, said inputs coupled to receive said monitoring station outputs, and said outputs storing data.

24. A machine-readable medium having stored thereon information representing the apparatus of claim 21.

25. A method comprising:
receiving information related to an animal;
comparing said information against a limit to produce a value; and
issuing an alert if said value is outside of said limit.

26. The method of claim 25 wherein said information is selected from the group consisting of heart rate, temperature, feed usage, water usage, respiration, movement, location, who is handling said animal, and environmental information.

27. The method of claim 25 wherein said limit is a range.

28. The method of claim 25 wherein issuing said alert is sent via a communication selected from the group consisting of email, instant message, paging, voice, video, and data.

29. The method of claim 25 further comprising sending a message to one or more persons.

30. An apparatus comprising:
a water monitoring device having an input and an output, said input in fluidic communication with water;
a monitoring station having an input and an output, said input coupled to receive said water monitoring device output;
a display having an input and an output, said input coupled to receive said monitoring station output, and said output presenting visual information to a user.

31. An apparatus comprising:
a plurality of standalone monitors having inputs and outputs, said inputs coupled to receive animal related information;
a plurality of local display units, having inputs and outputs, said inputs coupled to receive said standalone monitor outputs, and one or more of said outputs for presenting a first visual display;
one or more remote display units having inputs and outputs, said inputs coupled to receive said standalone monitor outputs, and one or more of said outputs for presenting a second visual display;
one or more monitoring systems having inputs and outputs, said inputs coupled to receive one or more inputs from one or more sources selected from the group consisting of standalone monitor, local display unit, and remote display unit; and one or more of said outputs for presenting a third visual display.

32. The apparatus of claim 31 wherein said standalone monitors and said local display units and said monitoring systems are capable of bi-directional communications between themselves and each other.

33. The apparatus of claim 31 wherein said first visual display, said second visual display, and said third visual display provide information selected from the group consisting of heart rate, water usage, respiration, temperature, movement, tracking of location, and who is handling an animal.

34. The apparatus of claim 33 wherein said information is substantially real-time.
